(19) United States
(12) Patent Application Publication
(10) Pub. No.: US 2021/0376547 A1
(43) Pub. Date: Dec. 2, 2021

(54) PORT CLEANERS WITH FLEXIBLE BODIES

(71) Applicant: HEWLETT-PACKARD DEVELOPMENT COMPANY, L.P., SPRING, TX (US)

(72) Inventors: KATIA BENSON, FORT COLLINS, CO (US); HUI HE, FORT COLLINS, CO (US); RYAN MOORE, MILWAUKEE, WI (US)

(21) Appl. No.: 16/652,795

(22) PCT Filed: Nov. 29, 2017
(86) PCT No.: PCT/US2017/063762

§ 371 Date: Apr. 1, 2020

(51) Int. Cl. H01R 43/00; B08B 9/043

(52) U.S. Cl. CPC H01R 43/002; H01R 24/60; B08B 2209/04; B08B 9/0436

(57) ABSTRACT

In an example, a port cleaner may include a flexible body, a guide wire, and a push plate. The guide wire may extend along a length of the flexible body. Further, the push plate may be disposed at a first end of the flexible body and movable along the guide wire to compress the flexible body.

### BACKGROUND

Electronic devices may include communication ports to receive connectors, cables, and other types of components for the transfer of data, power, and/or other signals to or from the electronic device. Such communication ports may include electrical contacts or other signal transfer elements to engage with complementary contacts or elements disposed on a component engaged with the communication port. Engagement of the signal transfer elements within a communication port with complementary contacts or elements may enable such transfer of data, power, and/or other types of signals.

### BRIEF DESCRIPTION OF THE DRAWINGS

FIG. 1A is a perspective view of an example port cleaner.

FIG. 1B is a perspective view of an example port cleaner.

FIG. 2A is a perspective view of an example port cleaner.

FIG. 2B is a perspective view of an example port cleaner.

FIG. 3A is a perspective view of an example communication port having an example port cleaner.

FIG. 3B is a cross-sectional view of an example communication port having an example port cleaner.

FIG. 3C is a cross-sectional view of an example communication port having an example port cleaner.

FIG. 3D is a cross-sectional view of an example communication port having an example port cleaner.

### DETAILED DESCRIPTION

Electronic devices may communicate with other devices through the use of communication ports disposed on the electronic devices. Such communication ports may receive and mechanically and operably engage with complementary plugs or connectors to enable such communication between devices. Specifically, communication ports may include electrical contacts or other signal transfer elements which may operably engage with complementary electrical contacts or signal transfer elements of a plug or connector engaged with the communication port to enable the transfer of data and/or power signals between the electronic device and another device.

In some situations, electronic devices, and thus communication ports disposed thereon, may be exposed to water, coffee, rain, sweat or other moisture, chemicals, and/or other contaminants. Such contaminants may cause shorts, corrosion, or other detrimental effects on or within the communication ports, and signal transfer elements, e.g., electrical contacts, disposed therein. The accumulation of corrosion or other contaminants on the signal transfer elements may have a negative effect on the function of the communication port, and may inhibit the effective and efficient transfer of data and/or power signals through the communication port. Thus, it may be desirable to avoid the accumulation of such contaminants on the signal transfer elements of communication ports. In some situations however, exposure of the communication ports to such contaminants may be difficult to avoid, and thus it may further be desirable to clean or remove contaminants from the communication ports and the signal transfer elements disposed within them.

Traditional cleaning methods may include blowing compressed air into communication ports, or using toothpicks, cotton swabs, or similar items to clean out and remove foreign particles and contaminants from communication ports. While possibly useful for extracting larger and loose particles like dirt from the communication port, these existing methods may not be effective at removing finer contaminants, contaminants that have built up on or become attached to the signal transfer elements of the communication ports, or contaminants that result from a chemical reaction, such as corrosion. Further, in some situations, inserting or forcing foreign objects like cotton swabs, toothpicks, or the like into a communication port to clean it may actually result in damaging often-delicate components disposed within the communication port, thus resulting in the cleaning process negatively affecting the function of the communication port further. Therefore, it may be desirable in some situations to use a cleaning device that is designed and structured for the type of port to be cleaned, and/or may be inserted easily and smoothly into a communication port, thereby minimizing the possibility of damaging the communication port or components disposed within it. Further, it may also be desirable for such a cleaning device, once disposed within a communication port, to press against or exert a pressure on signal transfer elements within the communication port to wipe away or clean contaminants that have built up on or become attached to them, and thereby effectively improving the function of the communication port.

Implementations of the present disclosure provide port cleaners with flexible bodies to wipe, clean, and/or remove contaminants disposed on signal transfer elements, e.g., electrical contacts, of a communication port. Example port cleaners disclosed herein may be sized and structured so as to engage with a communication port in a safe and smooth manner, while engaging with the signal transfer elements within the communication port in order to effectively clean and improve performance of the communication port.

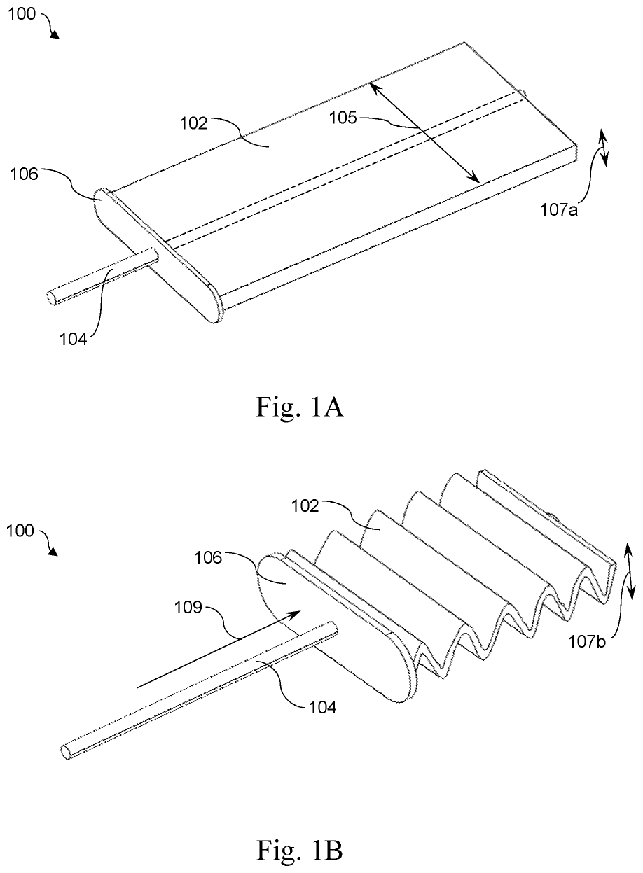

Referring now to FIG. 1A, a perspective view of an example port cleaner 100 is illustrated. Example port cleaner 100 may include a flexible body 102, a guide wire 104 extending along a length of the flexible body 102, and a push plate 106 disposed at a first end of the flexible body and movable along the guide wire 104 to compress the flexible body 102. The flexible body 102 may be a deformable member, plate, or panel. In other implementations, the flexible body 102 may be resilient and/or at least partially elastically deformable so as to return, at least partially, to its starting shape after undergoing a deformation, e.g., a compression. Further, the flexible body 102 may be constructed of a soft material, for example, a fabric or cloth. In yet further implementations, the flexible body 102 may include a material such as cotton, alcantara, foam, or another fabric, cloth, or soft material, or a combination thereof. In other implementations, the flexible body 102 may have an abrasive material which may be abrasive enough to wipe away or clean contaminants from a surface, yet also be soft enough to avoid damaging the surface while doing so. In some implementations, the flexible body 102 of the port cleaner 100 may include a width 105 and an operable thickness 107a suitable to insert into a communication port of an electronic device. In other words, the flexible body 102 may include a width 105 and operable thickness 107a substantially matching that, or smaller than, a width and height, respectively, of a communication port with which the port cleaner 100 may be engaged or inserted. In some situations, the operable thickness 107a may be referred to as an undeformed operable thickness 107a, or a starting operable thickness.

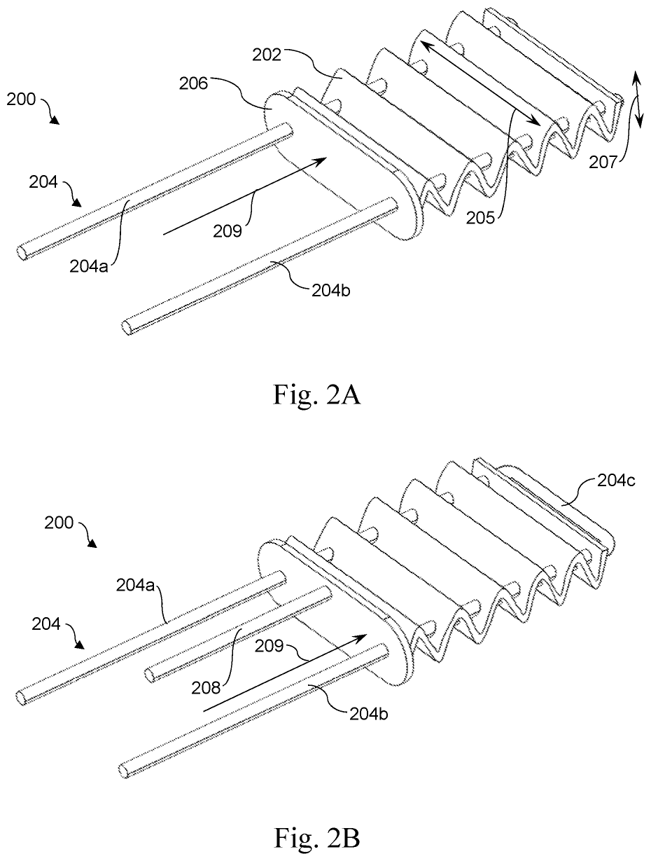

The guide wire 104 may be an elongate member which may extend, at least substantially, along the length of the flexible body 102. In some implementations, the guide wire 104 may be a rod, pin, wire, or another suitably elongate component. In further implementations, the guide wire 104 may have a circular or rounded cross-section. In other implementations, the guide wire 104 may have a cross-section with a different shape. In some implementations, the guide wire 104 may be a wire having a coating or sheath, and in further implementations, the guide wire 104 may have a diameter of approximately one half millimeter (0.5 mm). In the illustrated example of FIG. 1A, the guide wire 104, shown partially in phantom, may extend along and be substantially disposed within the flexible body 102. In some implementations, the guide wire 104 may extend along the flexible body 102 within a hole, channel, or bore of the flexible body 102. In other implementations, the guide wire 104 may be weaved through the flexible body 102, and/or through an array of apertures thereon, and along the length of the flexible body 102, as described below with regard to FIGS. 2A-2B. In yet further implementations, the guide wire 104 may extend, at least partially, out of the flexible body at a second end, opposite from the first end where the push plate 106 may be disposed. The guide wire 104 may be attached or fixed to the second end of the flexible body 102 or, in other implementations, may be tied in a knot or have a crimp or other deformation or feature so as to retain that end of the guide wire 104 to the second end of the flexible body 102. Thus, if the flexible body 102 is pushed and/or deformed from the first end, the guide wire 104 will not pull through or be removed from the flexible body 102.

The push plate 106 may be a panel, plate, or other substantially flat member and may be disposed at a first end of the flexible body 102. In some implementations, the push plate 106 may be movable along the guide wire 104 and/or relative to the guide wire 104. In further implementations, the push plate 106 may have an opening, hole, or other type of aperture to receive the guide wire 104 and through which the guide wire 104 may be pulled or moved. The push plate 106 may be abutted, disposed, or pressed up against the first end of the flexible body 102. In some implementations, there may exist an intermediary component, or a plurality of intermediary components, disposed in between the push plate 106 and the flexible body 102, but which may still transfer force exerted in a pushing direction on the push plate 106 into a corresponding force exerted on the first end of the flexible body. In some implementations, the push plate 106 may be flat, yet in other implementations, the push plate 106 may have a different contour, for example a contour that meshes with, is complementary to, or substantially matches, the shape or profile of the first end of the flexible body 102, or an intermediary component therebetween.

Referring now to FIG. 1B, a perspective view of example port cleaner 100 is illustrated wherein the push plate 106 has been moved along the guide wire 104 in a pushing direction 109. The push plate 106 may be disposed on the guide wire 104, and abutted against or otherwise engaged with the flexible body 102 in such a way so as to compress the flexible body 102 if the push plate 106 is moved along the pushing direction 109, and/or a pushing force is exerted against the push plate 106 along such a pushing direction 109. In some implementations, the pushing force may be exerted by, and/or the push plate 106 may be moved along the pushing direction 109 by a user holding the guide wire 104 stationary and pushing on the push plate 106. Further, the push plate 106 may compress and/or deform the flexible body 102 such that the flexible body 102 expands in operable thickness. In this context, operable thickness may refer to the extent that the flexible body 102 extends in a dimension normal to the width 105, and substantially normal to the pushing direction 109. In other words, upon being compressed and/or otherwise deformed by the push plate 106, the operable thickness of the flexible body 102 may increase, and may be referred to as deformed operable thickness 107b, in some situations. The deformed operable thickness 107b is greater than the undeformed operable thickness 107a. In some implementations, the flexible body 102 may expand in operable thickness by being compressed into a wave-like or undulating orientation or geometry by the push plate, as illustrated in FIG. 1B. In further implementations, instead of the push plate 106 moving along the guide wire 104 in order to compress the flexible body 102, the push plate 106 and the guide wire 104 may both move along the pushing direction 109 in order to compress the flexible body 102. In such a situation, the guide wire 104, or a portion thereof, may be sufficiently disposed within the flexible body 102 such that the guide wire 104 and the flexible body 102 are both compressed into a wave-like or undulating fashion. Therefore, while the flexible body 102 is uncompressed, and has an undeformed operable thickness 107a, the port cleaner 100, or the flexible body 102 thereof, may be inserted into a communication port of an electronic device smoothly, and without damaging or having a negative effect on components, e.g., signal transfer elements, disposed within the communication port. Upon the flexible body 102 being sufficiently disposed within the communication port, the push plate 106 may be moved in the pushing direction 109 so as to compress and/or deform the flexible body 102 to cause the operable thickness of the flexible body 102 to increase to deformed operable thickness 107b. While the flexible body 102 is compressed and has an operable thickness 107b, the flexible body may contact or be pressed against signal transfer elements within the communication port.

Referring now to FIG. 2A, a perspective view of another example port cleaner 200 is illustrated. Example port cleaner 200 may be similar to example port cleaner 100, described above. Further, the similarly-named elements of example port cleaner 200 may be similar in function and/or structure to the respective elements of example port cleaner 100, as they are described above. Port cleaner 200 may include a flexible body 202, a guide wire 204, and a push plate 206. In some implementations, the push plate 206 may be disposed at a first end of the flexible body 202 and may compress the flexible body 202, thereby reducing the length of the flexible body 202, if the push plate 206 is moved along the guide wire 204 in a pushing direction 209. The flexible body 202 may have a width 205 and an operable thickness 207. Operable thickness 207 may represent the extent to which the flexible body 202 extends in a direction substantially normal to the width 205 and the pushing direction 209 when the flexible body 202 is compressed, as illustrated in FIG. 2A.

The guide wire 204, in some implementations, may include two separate portions, for example, first guide portion 204a and second guide portion 204b, disposed across the width 205 of the flexible body 202 and along the length of the flexible body 204, along which the push plate 206 may be movable. The push plate 206 may be moved along the pushing direction 209 relative to the first guide portion 204a and the second guide portion 204b in order to compress the flexible body 202 along its length and increase the operable thickness 207. In some implementations, the push plate 206 may be moved along the pushing direction 209 by a user holding the guide wire 204, or the first guide portion 204a and the second guide portion 204b thereof, secure or stationary, while pushing the push plate 206 along the pushing direction 209.

In some implementations, the guide wire 204, or the first guide portion 204a and the second guide portion 204b thereof, may be weaved in and out of or through the flexible body 202 and along the length of the flexible body 202. Thus, upon being compressed by the push plate 206, the flexible body 202 may develop or take on a wave-like or undulating geometry or orientation in order to increase the operable thickness 207.

Referring additionally to FIG. 2B, another example of port cleaner 200 is illustrated. In such an example, the two guide portions of the guide wire 204, i.e., the first guide portion 204a and the second guide portion 204b, may be connected at a second end of the flexible body 202, opposite from the first end, by a connecting portion 204c. Thus, in some implementations, the guide wire 204 may include a substantially U-shaped geometry, or another similar geometry having two adjacent portions and a connecting portion therebetween.

In further implementations, the port cleaner 200 may also include a pushing member 208 extending from the push plate 206 away from the flexible body 202. The pushing member 208 may be a rigid or semi-rigid elongate member such as a pin, rod, tab, or post, or a member having another shape. The pushing member 208 may assist in moving the push plate 206 along the guide wire 204 so as to compress the flexible body 202. For example, in some implementations, a user may hold the guide wire 204 stationary while holding and pushing on the pushing member 208 to move the push plate 206 along the pushing direction 209.

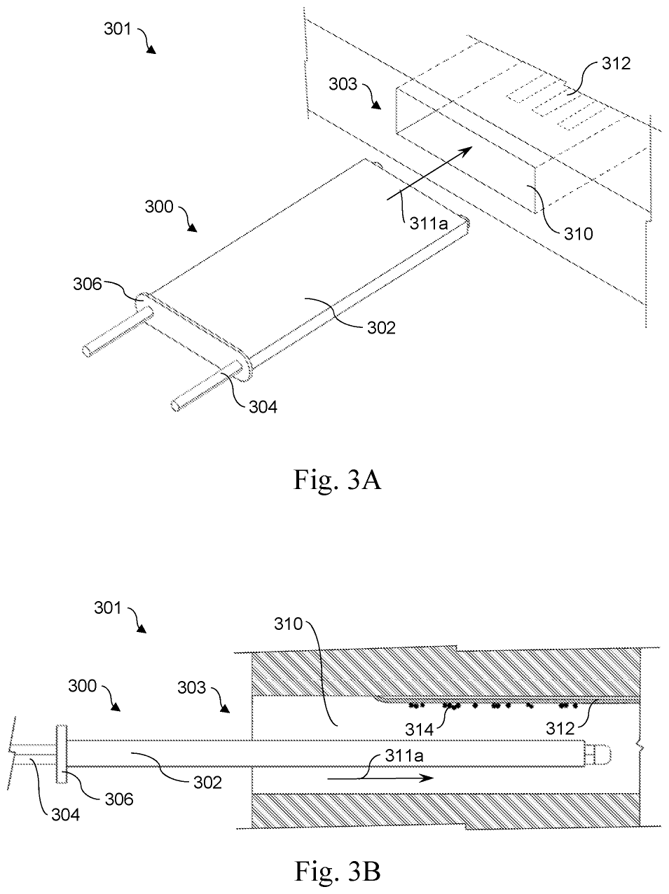

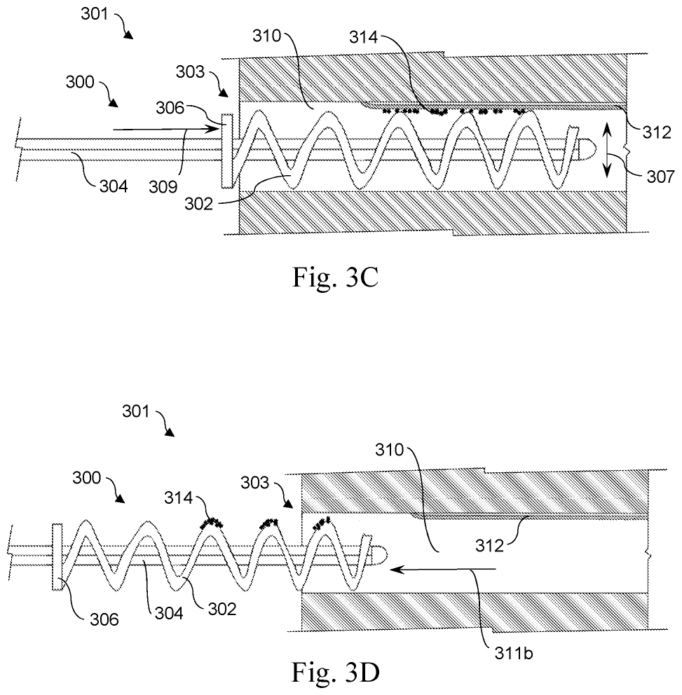

Referring now to FIG. 3A, a perspective view of an example communication port 303 of an electronic device 301 is illustrated. The communication port 303 may include an inner cavity 310, an electrical contact 312 or other signal transfer element (hereinafter generally referred to as an electrical contact 312) disposed within the inner cavity 310, and a removable port cleaner 300. Port cleaner 300 may be insertable into, and removable from, the inner cavity 310. Example port cleaner 300 may be similar to other example port cleaners described above. Further, the similarly-named elements of example port cleaner 300 may be similar in function and/or structure to the respective elements of other example port cleaners, as they are described above. In some implementations, the port cleaner 300 may include a flexible body 302, a guide wire 304, and a push plate 306. The flexible body 302 may be compressible from an undeformed shape to a deformed shape by pushing on the push plate 306.

The electronic device 301 may be a computing device, in some implementations. In further implementations, the electronic device 301 may be a notebook computer, a tablet computer, a desktop computer tower or display, an all-in-one computing device, a smartphone, or another type of computing device. In other implementations, the electronic device may be a device charger, a connector cable, an extension cable, or any other device having a communication port for the transfer of data, power, optical, or other signals. Correspondingly, the communication port 303 may be a Universal Serial Bus (USB) port (e.g., type A, type B, type C, Micro USB, Mini USB, or other USB port types), a memory card slot (e.g., a Secure Digital (SD), Micro SD, Mini SD memory card slot), a FireWire port, a Subscriber Identity Module (SIM) card slot, a High Definition Multimedia Interface (HDMI) port or another display port, a Serial Advanced Technology Attachment (SATA) or External SATA (eSATA) port, an Ethernet port, a Thunderbolt port, a headphone jack, or any other type of communication port having a signal transfer element for the transfer of data and/or power, or other signals. In other implementations, the communication port 303 may be an optical communication port, and the electrical contact 312 may be an optical connector component. In further implementations, the communication port 303 may have a plurality of electrical contacts 312 disposed within the inner cavity 310.

The electrical contacts 312 may be arranged in an array or layout within the communication port 303 specific to the type of communication protocol or technology utilized by the communication port 303, or for which the communication port 303 is designed. Similarly, the communication port 303 may have a physical structure, i.e., a width and a height, specific to the type of communication port. Accordingly, the port cleaner 300 may be specifically structured for use in a certain type of communication port 303, in some implementations. For example, the port cleaner 300 may have a flexible body 302 with a width, an operable thickness, and a length suitable to insert into, for example, along insert direction 311a, the inner cavity 310 of the communication port 303. In other words, the flexible body 302 may be sufficiently sized and structured to insert into or for use in a specific type of communication port 303. In some implementations, the body 302 may have a size and shape (e.g., a width and operable thickness) suitable to insert safely (i.e., without causing damage) into a USB port, a SIM card slot or port, a SD memory card slot, or another type of specific communication port of an electronic device. In other implementations, the port cleaner 300 may have a width and operable thickness suitable to safely insert into a plurality of different types of communication ports. In other words, the port cleaner 300 may be used to insert into and clean out multiple types of communication ports, sometimes disposed on the same electronic device.

Referring additionally to FIG. 3B, a cross-sectional view of the communication port 303 of the electronic device 301 is illustrated, wherein the port cleaner 300 has been inserted into, or is disposed within the inner cavity 310 of the communication port 303. FIG. 3B illustrates a single electrical contact 312 having corrosion or other contaminants 314 that have built up on or otherwise attached to the electrical contact 312. It should be noted that, while only a single electrical contact 312 is illustrated, multiple electrical contacts 312 may be present within the communication port 303, and the below-described function may apply to some or all of the electrical contacts 312. In other words, the flexible body 302 of the port cleaner 300 may have a width suitable to engage with multiple electrical contacts 312, or an entire array or arrangement of electrical contacts 312 within the communication port 303. Additionally, in some implementations, the communication port 303 may also have electrical contacts 312 disposed on the bottom of the inner cavity, and the port cleaner 300, further, may be able to clean off such electrical contacts.

FIG. 3B illustrates the port cleaner 300 as being inserted into the inner cavity 310 while the flexible body 302 is disposed in the undeformed or uncompressed orientation. As such, the port cleaner 300 is inserted in a safe manner into the inner cavity 310, thereby avoiding the possibility of damaging any components disposed within the communication port 303. The port cleaner 300 is inserted into the inner cavity 310 such that the flexible body 302 is at least partially aligned width electrical contacts within the inner cavity 310. Further, upon the port cleaner 300, and the flexible body 302 thereof, being inserted into the inner cavity 310, the push plate 306 may be left disposed outside of the inner cavity 310. This way, a user or another mechanism can still access the push plate 306 to push it in a pushing direction.

Referring now to FIG. 3C, a cross-sectional view of the communication port 303 of the electronic device 301 is illustrated, wherein the flexible body 302 has been compressed and/or deformed so as to increase its operable thickness 307. Since the push plate 306 has been left disposed outside of the inner cavity 310, a user or another mechanism may have pushed on or otherwise moved the push plate 306 in a pushing direction 309. In some implementations, the pushing direction 309 may be substantially parallel or along the same direction as the insert direction 311a. Upon moving the push plate 306 in the pushing direction, the push plate 306 may have moved along the guide wire 304 and, further, may have deformed the flexible body 302, for example, into a wave-like pattern or orientation, so as to increase the operable thickness 307 of the flexible body 302. In other words, the push plate 306 may compress the flexible body 302 within the inner cavity 310. The operable thickness 307 of the flexible body 302 may increase to the point where the flexible body 302 contacts or presses against the electrical contact 312 (or other electrical contacts within the inner cavity 310). Stated another way, the flexible body 302 may expand in operable thickness upon being compressed so as to press against electrical contacts or other signal transfer elements within the inner cavity 310.

Referring now to FIG. 3D, a cross-sectional view of the example communication port 303 is illustrated wherein the port cleaner 300 has been partially withdrawn, extracted, or otherwise removed from the inner cavity 310, or is in the process of fully withdrawing from the inner cavity 310, for example, along withdraw direction 311b. Withdraw direction 311b may be opposite to the insert direction 311a, in some implementations. As the port cleaner 300 is withdrawn from the inner cavity 310 of the communication port 303, the flexible body 302 is to slide, scrape, or wipe along the electrical contact 312. In other words, the compressed flexible body 302 may wipe or slide along the electrical contact 312 if the flexible body 302 is withdrawn from the inner cavity 310 of the communication port 303. Such wiping or scraping action of the flexible body 302 is to clean, wipe, and/or remove moisture, corrosion, or other contaminants 314 from the electrical contact 312 (or other electrical contacts the flexible body 302 may be in contact with in its deformed and/or compressed state). Accordingly, contaminants 314 are illustrated as being disposed on the flexible body 302 in FIG. 3D, instead of on the electrical contact 312. In implementations wherein the flexible body 302 is compressed into a wave-like orientation, the crests of such waves may wipe or scrape along the electrical contacts, pulling contaminants 314 from the electrical contacts through such action. In other words, examples of port cleaners disclosed herein may be inserted safely into a communication port while the flexible body is undeformed, or in its flat state. The flexible body may then be compressed into a deformed state, thereby pressing against signal transfer elements within the communication port, and wiped along the signal transfer elements to remove contaminants thereon, thereby cleaning the signal transfer elements and improving the function of the communication port in transferring data, power, and/or other signals, or avoiding the inhibition of such function.

What is claimed is:

1. A port cleaner, comprising:
a flexible body;
a guide wire extending along a length of the flexible body; and
a push plate disposed at a first end of the flexible body and movable along the guide wire to compress the flexible body.

2. The port cleaner of claim 1, wherein the flexible body comprises a width and operable thickness suitable to insert into a communication port of an electronic device.

3. The port cleaner of claim 2, wherein the push plate is to compress the flexible body if moved along a pushing direction such that the flexible body expands in operable thickness.

4. The port cleaner of claim 3, wherein the flexible body is to expand in operable thickness by being compressed into a wave-like orientation by the push plate.

5. The port cleaner of claim 2, wherein the body comprises a width and operable thickness suitable to insert into a Universal Serial Bus (USB) port of an electronic device.

6. The port cleaner of claim 2, wherein the body comprises a width and operable thickness suitable to insert into a Secure Digital (SD) memory card port of an electronic device.

7. A port cleaner, comprising:
a flexible body having a width and operable thickness smaller than a width and height of a communication port of an electronic device;
a guide wire weaved through the flexible body along a length of the flexible body; and
a push plate disposed at a first end of the flexible body and movable along the guide wire, the push plate to compress the flexible body if the push plate is moved along the guide wire in a pushing direction.

8. The port cleaner of claim 7, wherein the push plate is to compress the flexible body such that, if moved along the pushing direction, the flexible body expands in operable thickness.

9. The port cleaner of claim 8, wherein the flexible body is to expand in operable thickness by being compressed into a wave-like orientation by the push plate.

10. The port cleaner of claim 8, wherein the guide wire comprises two separate guide portions disposed across the width of the flexible body and extending along the length of the flexible body and along which the push plate is movable.

11. The port cleaner of claim 10, wherein the two guide portions are connected at a second end of the flexible body such that the guide wire comprises a substantially U-shaped geometry.

12. The port cleaner of claim 8, wherein the push plate comprises a pushing member extending from the push plate away from the flexible body.

13. A communication port of an electronic device, comprising:
an inner cavity;
a signal transfer element disposed within the inner cavity; and
a removable port cleaner, comprising:
a flexible body having a width and operable thickness suitable to insert into the inner cavity;
a guide wire extending and weaved along a length of the flexible body; and
a push plate disposed at a first end of the flexible body and movable along the guide wire to compress the flexible body within the inner cavity.

14. The communication port of claim 13, wherein the push plate is to compress the flexible body if moved along a pushing direction such that the flexible body expands in operable thickness to press against the signal transfer element.

15. The communication port of claim 14, wherein the compressed flexible body is to wipe along the signal transfer element if the flexible body is withdrawn from the inner cavity.
